(19) United States
(12) Patent Application Publication
(10) Pub. No.: US 2007/0158293 A1
(43) Pub. Date: Jul. 12, 2007

(54) Bottle package having an EAS label and an advertising label covering the same

(75) Inventor: Jean-Charles Andreani, Ballans (FR)

Correspondence Address: MILLER, MATTHIAS & HULL, ONE NORTH FRANKLIN STREET, SUITE 2350, CHICAGO, IL, 60606, US

(73) Assignee: Societe JAS HENNESSY ET COMPAGNIE, Cognac (FR)

(21) Appl. No.: 11/319,018

(22) Filed: Dec. 23, 2005

(51) Int. Cl. A47J 41/02; B65D 23/00

(52) U.S. Cl. 215/12.1

(57) ABSTRACT

Bottle package comprising: a bottle having a wall, an EAS label sticked to the bottle wall, an advertising label sticked to the bottle wall, wherein the advertising label covers the EAS label. A recess is formed in the bottle wall, or an embossment is formed in the advertising label to receive the EAS label.

### FIELD OF THE INVENTION

The invention relates to a bottle package equipped with an electronic article surveillance (EAS) label, to a method for making the same and to a method for manufacturing an advertising label suitable for such a bottle package.

### BACKGROUND OF THE INVENTION

Electronic surveillance systems are well known in the art. A typical application is theft prevention: the article is prevented from being removed in an unauthorized manner from a controlled area. In order to be removed from the controlled area, the article must traverse an interrogation zone where the EAS label attached to the article is detected by an EAS system which responds to the detection with a predetermined action, such as deactivation of an alarm system.

Such systems are commonly used for wine and spirit bottles, as the precious alcohol they carry must be preserved from stealing.

Typical magnetomechanical EAS labels are known under the brand names ULTRA●MAX® and ULTRA●STRIP®, sold by the SENSORMATIC ELECTRONICS CORPORATION. Such EAS label are taught in the U.S. Pat. No. 6,822,569 to Bellum et al, 4,510,489 to Anderson, III et al, and 4,254,868 to Humble et al.

It is known to stick the EAS label to the bottle, on a side thereof, or even under its bottom (as taught on B&G PLASTICS, INC's website, www.bgplastics.com).

The paper backing of the EAS label is simply removed, and the label applied automatically or manually on the bottle.

One drawback of such a bottle package is that the EAS label creates visual pollution of the package. EAS label manufacturers have tried to customize their labels, but there is still a visual inconvenience, since the label is often put where there should be nothing but clean glass.

The main drawback of EAS labels to be put under the bottom of the bottles is that they must be shaped and dimensioned for every type of bottle, thereby preventing standardized manufacturing.

In addition, unsticking an EAS label is somewhat easy, which facilitates the stealing of the corresponding bottle.

### SUMMARY OF THE INVENTION

It is one object of the invention to overcome the above-mentioned drawbacks, providing a bottle package equipped with an EAS label which is more discrete.

It is another object of the invention to provide a bottle package equipped with an EAS label which is more difficult to remove from the bottle.

It is a further object of the invention to provide a method for making such a bottle package.

It is a further object of the invention to provide a method for manufacturing an advertising label suitable for such a bottle package.

The invention therefore provides, according to a first aspect, a bottle package comprising:

a bottle having a wall,

an EAS label sticked to the bottle wall,

an advertising label sticked to the bottle wall,

wherein the advertising label covers the EAS label.

In a first embodiment: the bottle wall is provided with a recess wherein the EAS label is received, said recess having a width and a length close to or greater than a width and a length of said EAS label.

The recess preferably has a depth close to or greater than a thickness of said EAS label.

In a second embodiment, the advertising label is provided with an embossment, wherein the EAS label is received, said embossment having a width and a length greater than a width and a length of said EAS label, respectively,

The embossment preferably has a depth greater than a thickness of said EAS label.

The invention provides, according to a second aspect, a method of making a bottle package, comprising the steps of:
providing a bottle having a wall,
providing an EAS label,
sticking said EAS label to said bottle wall,
providing an advertising label,
sticking said advertising label to said bottle wall over said EAS label.

A method of making a bottle package according to the first embodiment, comprises the steps of:
providing a bottle having a wall, said bottle wall having a recess,
providing an EAS label,
sticking said EAS label to said bottle wall in said recess,
providing an advertising label,
sticking said advertising label to said bottle wall over said EAS label.

A method of making a bottle package according to the second embodiment comprises the steps of:
providing a bottle having a wall,
providing an EAS label,
sticking said EAS label to said bottle wall,
providing an advertising label having an embossment,
sticking said advertising label to said bottle wall over said EAS label, whereby said EAS label is received in said embossment.

The invention also provides a method of manufacturing an advertising label for a bottle package according to the second embodiment, said method comprising the steps of:
providing a top sheet under the form of a continuous strip of long fiber paper,
providing an adhesive compound, preferably in the of an acrylic emulsion,
applying said adhesive compound to a back side of said top sheet to form a pressure sensitive adhesive layer;
providing a backing web layer under the form of a continuous strip,
applying said backing web to said adhesive layer,
providing ink,
printing advertising information on a front side of said top sheet,
providing a varnish compound,
applying said varnish compound to the printed front side of said top sheet, thereby forming a composite structure,
embossing said composite structure to form an embossment having a concavity on the side of the backing web.

Preferably, the top sheet paper is a woodless paper. Its grammage may be of 210 g/m², and its thickness of 0.25 mm.

The backing web is e.g. made of a polyester film, a side of which is coated with silicon. For example, its thickness is of 36 μm, and it may have a grammage of 50.8 g/m².

The above and other objects and advantages of the invention will become apparent from the detailed description of preferred embodiments of the invention, considered in conjunction with the accompanying drawings.

### BRIEF DESCRIPTION OF THE DRAWINGS

FIG. 1 is an elevational front view of a bottle package according to a first embodiment of the invention;

FIG. 2 is a partial sectional view of the bottle shown on FIG. 1, taken along line II-II;

FIG. 3 is a partial sectional view of the bottle shown on FIG. 1, taken along line III-III of FIG. 2;

FIG. 4 is a perspective exploded partial view showing the bottle package of FIG. 1;

FIG. 5 is a partial sectional view of the bottle package of FIG. 1, taken along line V-V;

FIG. 6 is an elevational front view of a bottle package according to a second embodiment of the invention;

FIG. 7 is a perspective exploded partial view showing the bottle package of FIG. 6;

FIG. 8 is a partial sectional view of the bottle package of FIG. 6, taken along line VIII-VIII;

FIG. 9 is a diagram explaining the method according to the invention for manufacturing an advertising label for a bottle package according to the second embodiment;

FIG. 10 is a sectional view showing the sandwich structure of an advertising label suitable for a bottle package according to the second embodiment,

FIG. 11 is a diagram explaining the method for making a bottle package according to the invention.

### DETAILED DESCRIPTION

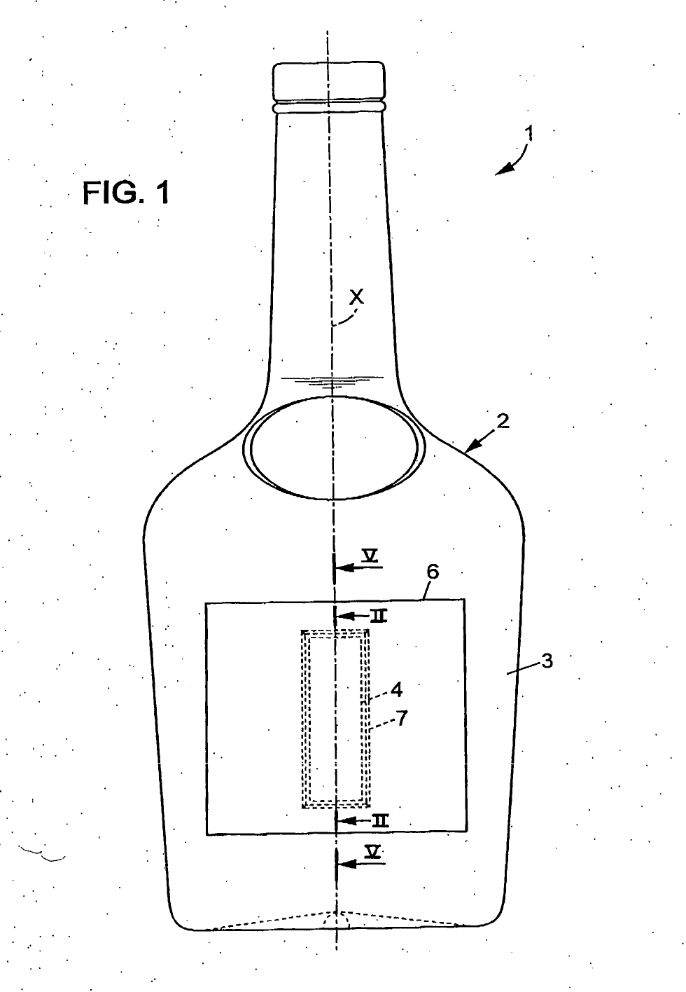

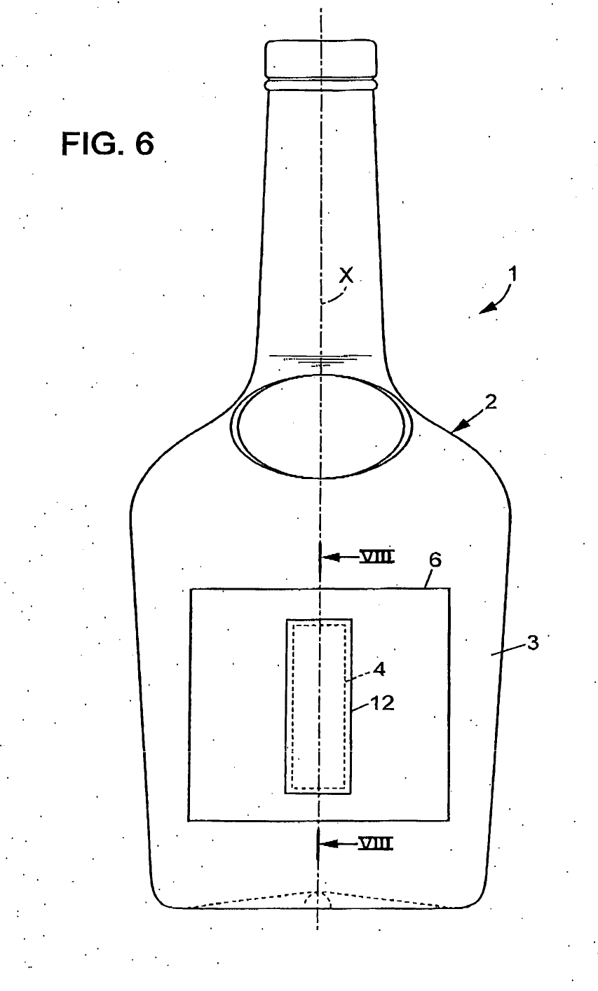

Referring now to FIGS. 1 and 6, there is shown a bottle package 1 comprising a bottle 2 having a glass wall 3 forming a container for a beverage such as wine or brandy. The bottle 2 has a main revolution symmetry axis X. The bottle package 1 also comprises an EAS label 4 sticked to the bottle wall 3. The EAS label 4 comprises a rigid plastic casing 5 enclosing a magnetimechanical device (not shown) detectable by an external EAS system (not shown). Such an EAS label is commonly available under the brand name of ULTRA●MAX® and ULTRA●STRIP®. In the depicted example, the casing 5 has a somewhat parallelepipedic shape, and has a thickness, a width much greater than the width, and a length much greater than the width.

In one embodiment, the dimensions of the EAS label 4 are as follows: length: 44.6 mm±0.15 mm; width: 10.16 mm±0.15 mm; thickness: 1.20 mm±0.13 MM, which correspond to the SENSORMATIC ULTRA●STRIP® Low Profile Label. Such an EAS label 4 is provided with a paper backing which has to be removed (pealed off) before sticking the EAS label to the bottle 2.

The bottle package 1 further comprises an advertising label 6, formed of a flexible printed adhesive card covered with a peelable backing web and including information about the product inside the bottle 2 (such as the brand name, the ingredients, legal information about the produced, etc.), sticked to the bottle wall 3 over the EAS label 4, i.e. it entirely covers the EAS label 4, whereby the EAS label 4 is out of reach unless the advertising label 6 is torn off from the bottle 2.

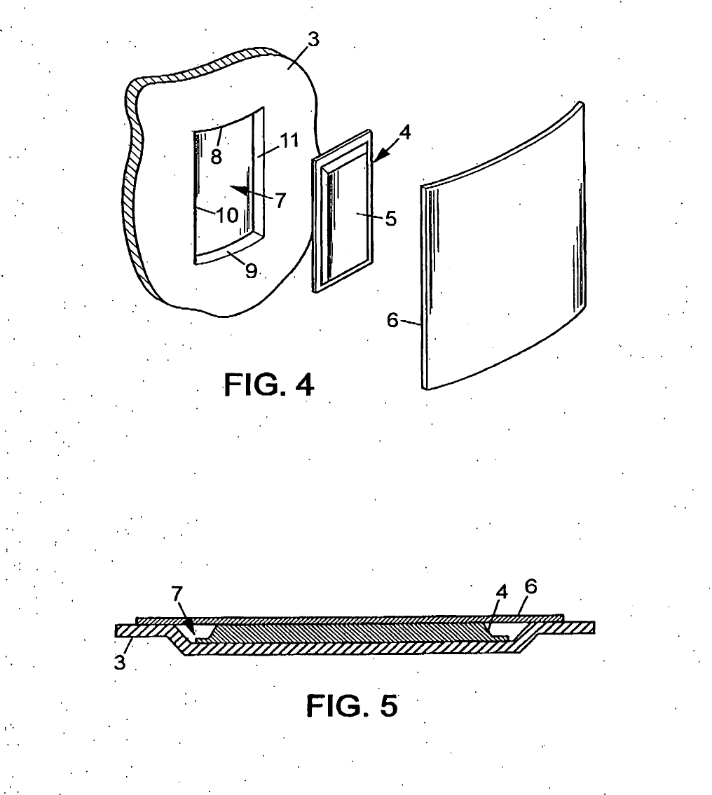

According to a first preferred embodiment, illustrated on FIGS. 1-5, the bottle wall 3 is provided with a recess 7 having a concavity turned outwards from the bottle 2, and wherein the EAS label 4 is received. Therefore, the recess 7, of rectangular shape, has a length L (corresponding on the bottle 2 to a height) close to or greater than the length of the EAS label 4, whereas it has a width W close to or greater than the width of the EAS label 4. The recess 7 also preferably has a depth D close to or greater than the thickness of the EAS label 4. Preferably, the depth D of the recess 7 is equal to or greater than 50% of the thickness of the EAS label, and, more precisely, it is preferably simply greater than the thickness of the EAS label 4.

In one embodiment, the dimensions of the recess 7 are as follows: length: L=51 mm; width: W=16 mm; depth: D comprised between 1.4 and 2.8 mm, in order to receive the SENSORMATIC ULTRA●STRIP® Low Profile Label, the dimensions of which are given hereabove.

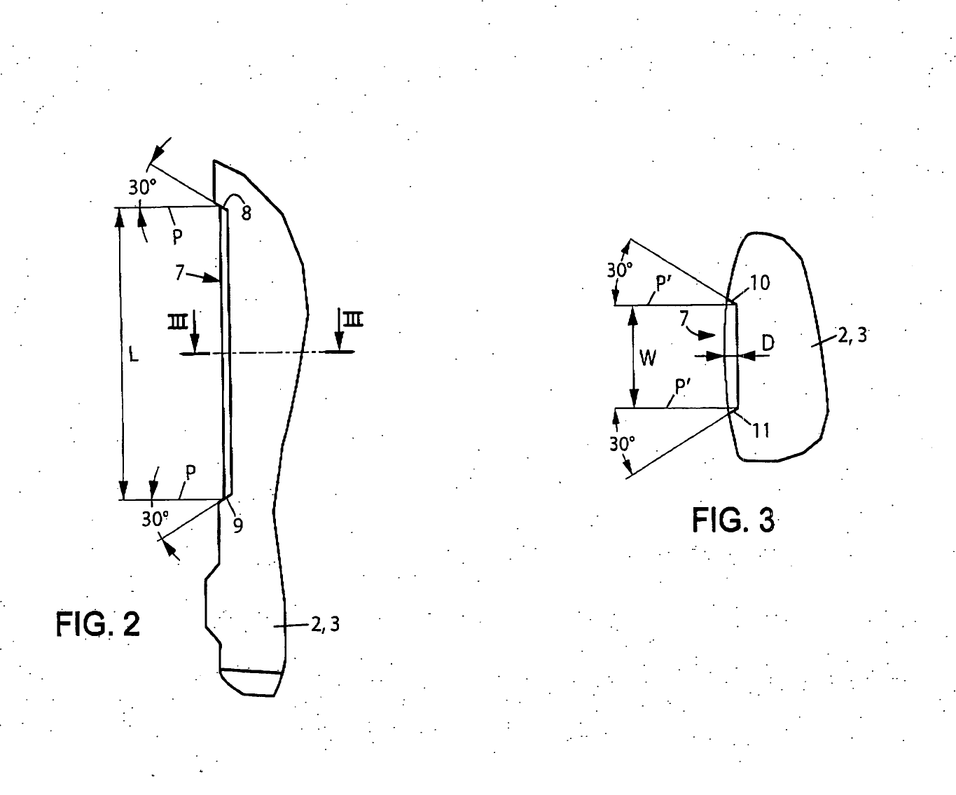

In order for the EAS label 4 to be easily put into the recess 7, transversal and side edges 8, 9, 10, 11 of the recess 7 may be beveled, preferably at an angle of approximately 30° with a plane P perpendicular to the bottle axis X, and with a plane P′ parallel to the bottle axis X, respectively, as shown on FIGS. 2 and 3.

A method for making the bottle package 1 according to the first embodiment comprises the following steps:
providing (100) the bottle 2,
providing (110) the EAS label 4,
pealing off (120) the paper backing of the EAS label 4 and sticking (130) the same to the bottle wall 3 inside the recess 7,
providing (140) the advertising label 6,
pealing off (150) the backing web of the advertising label 6 and sticking (160) the same to the bottle wall 3 over the EAS label 4, whereby the EAS label 4 is completely covered by the advertising label 6.

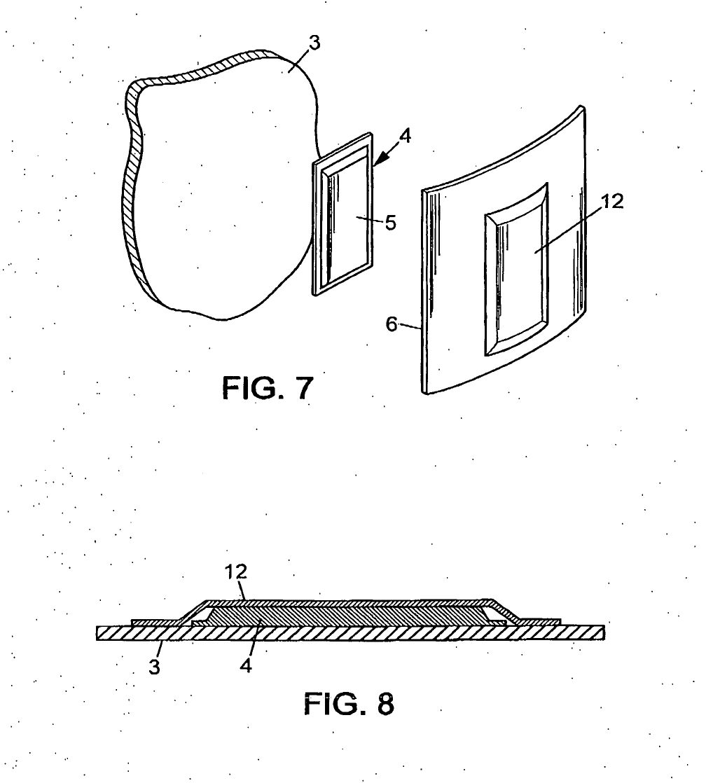

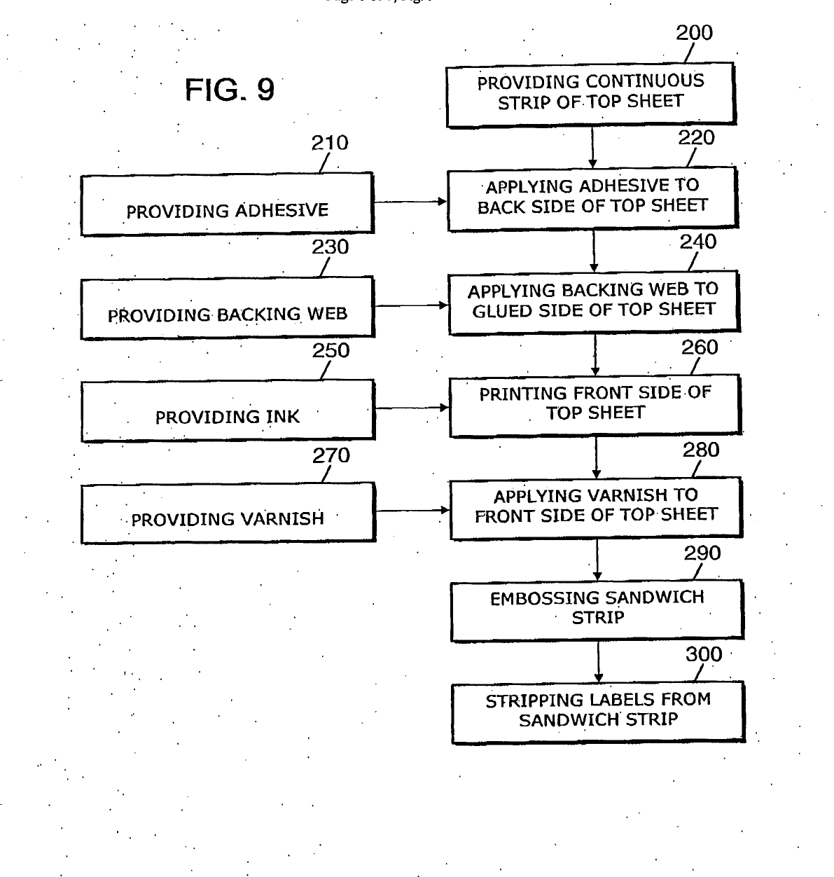

According to a second preferred embodiment, illustrated on FIGS. 6-8, the EAS label 4 is sticked to the bottle wall 3 in a flat region thereof (i.e. without any recess), whereas the advertising label 6 is provided with an embossment 12, a concavity of which is turned towards the bottle 2, and wherein the EAS label 4 is received. Therefore, the embossment 12, of rectangular shape, has a length (corresponding on the bottle to a height) greater than the length of the EAS label, whereas it has a width greater than the width of the EAS label. The embossment 12 also preferably has a depth greater than the thickness of the EAS label.

In one preferred embodiment, the dimensions of the embossment 12 correspond to the dimensions of the recess 7 disclosed in the first embodiment.

A method for making the bottle package 1 according to the second embodiment comprises the following steps:
providing (100) the bottle 2,
providing (110) the EAS label 4,
pealing off (120) the paper backing of the EAS label 4 and sticking (130) the same to the bottle wall 3,
providing (140) the advertising label 6,
pealing off (150) the backing web of the advertising label 6 and sticking (160) the same to the bottle wall 3 over the EAS label 4, in such a way the EAS label 4 is received in the embossment 12.

In order for the EAS label 4 to strongly stick to the bottle, it should preferably be chosen of the curved type, i.e. the side of the casing 5 facing the bottle 2 is concave, following the convexity of the bottle wall 3. An EAS label of this type is known in the art, and is also available by SENSORMATIC under the brand name ULTRA●STRIP® Low Profile Label.

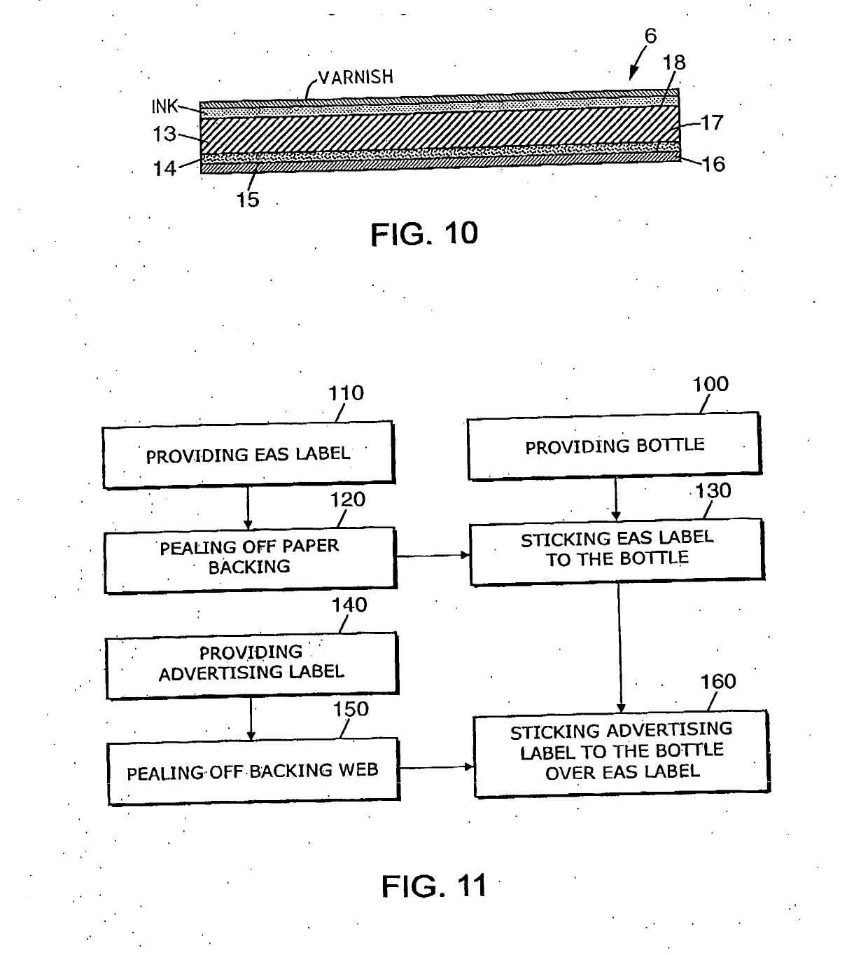

As depicted on FIG. 10, the advertising label 6 is in the form of a composite (i.e. sandwich, or multi-layer) structure. It has a top sheet 13 made of machine coated, calendered, semi-gloss, woodless paper, the grammage of which is preferably of 210 g/cm², whereas its thickness is of 0.25 mm. The advertising label 6 also has a pressure sensitive adhesive layer 14, which coats a back side 15 of the top sheet 13, and which is preferably made from an adhesive compound in the form of a reinforced acrylic emulsion, and a backing web layer 16, coating the adhesive layer 14 and made of a polyester film, a side 17 of which, in contact with the adhesive layer 14, is coated with silicon. In one embodiment, the backing web 16 has a thickness of 36 μm and a grammage of 50.8 g/m².

Such a structure is suitable for both bottle package embodiments disclosed hereabove. However, in the second embodiment the paper the top sheet is made of is preferably a long fibers paper, in order to prevent fissures to occur during the embossing operation.

A method of manufacturing an advertising label 6 for a bottle package 1 according to the second embodiment comprises the steps of:
providing (200) the top sheet 13, under the form of a continuous strip of long fiber paper,
providing (210) the adhesive compound,
applying (220) the adhesive compound to the back side 15 of the top sheet 13 in order to form the pressure sensitive adhesive layer 14;
providing (230) the backing web layer 16 under the form of a continuous strip,
applying (240) the backing web to the adhesive layer 14,
providing ink (250),
printing (260) advertising information on a front side 18 of the top sheet 13, opposite the back side 15,
providing (270) a varnish compound,
applying (280) the varnish compound to the printed front side 18 of the top sheet 13, thereby achieving the composite structure,
embossing (290) the composite structure to form an embossment 12 having a concavity on the side of the backing web layer 16, and
stripping (e.g. waste stripping) (300) labels 6 from the sandwich strip.

The embossing operation is preferably a hot embossing operation. As the paper is a long fiber one, no fissure will occur during the embossing operation. The combined choice of the paper and the adhesive, which is a strong one, results in an advertising label 6 which can not be manually unsticked as one piece: it will tear away and delaminate, thereby making it almost impossible to cleanly remove the EAS label 4 and consequently improving anti-theft properties of the bottle package. In addition, the bottle package according to the invention provides better visual aspect than the known one, since the EAS label is covered by the advertising layer.

1. Bottle package comprising:
a bottle having a wall,
an EAS label sticked to the bottle wall,
an advertising label sticked to the bottle wall,
wherein the advertising label covers the EAS label.

2. Bottle package according to claim 1,
wherein said bottle wall is provided with a recess,
wherein said recess has a width and a length greater than a width and a length of said EAS label, respectively,
and wherein said EAS label is received in said recess.

3. Bottle package according to claim 2, wherein said recess has a depth close to or greater than a thickness of said EAS label.

4. Bottle package according to claim 1,
wherein said advertising label is provided with an embossment,
wherein said embossment has a width and a length greater than a width and a length of said EAS label, respectively,
and wherein said EAS label is received in said embossment.

5. Bottle package according to claim 4, wherein said embossment has a depth close to or greater than a thickness of said EAS label.

6. Method of making a bottle package, comprising the steps of:
providing a bottle having a wall,
providing an EAS label,
sticking said EAS label to said bottle wall,
providing an advertising label,
sticking said advertising label to said bottle wall over said EAS label.

7. Method of making a bottle package, comprising the steps of:
providing a bottle having a wall, said bottle wall having a recess,
providing an EAS label,
sticking said EAS label to said bottle wall in said recess,
providing an advertising label,
sticking said advertising label to said bottle wall over said EAS label.

8. Method of making a bottle package, comprising the steps of:
providing a bottle having a wall,
providing an EAS label,
sticking said EAS label to said bottle wall,
providing an advertising label having an embossment,
sticking said advertising label to said bottle wall over said EAS label, whereby said EAS label is received in said embossment.

9. Method of manufacturing an advertising label for a bottle package, said method comprising the steps of:
providing a top sheet under the form of a continuous strip of long fiber paper,
providing an adhesive compound,
applying said adhesive compound to a back side of said top sheet to form a pressure sensitive adhesive layer;
providing a backing web layer under the form of a continuous strip,
applying said backing web to said adhesive layer,
providing ink,
printing advertising information on a front side of said top sheet,
providing a varnish compound,
applying said varnish compound to the printed front side of said top sheet, thereby forming a composite structure,
embossing said composite structure to form an embossment having a concavity on the side of the backing web.

10. Method according to claim 9, wherein said top sheet paper is a woodless paper.

11. Method according to claim 10, wherein said top sheet paper has a grammage of 210 g/m2.

12. Method according to claim 9, wherein said paper has a thickness of 0.25 mm.

13. Method according to claim 9, wherein said backing web is made of a polyester film, a side of which is coated with silicon.

14. Method according to claim 13, wherein said backing web has a thickness of 36 μm.

15. Method according to claim 13, wherein said backing web has a grammage of 50.8 g/m².

16. Method according to claim 9, wherein said adhesive compound is in the form of an acrylic emulsion.
